(19) United States
(12) Patent Application Publication
(10) Pub. No.: US 2008/0254964 A1
(43) Pub. Date: Oct. 16, 2008

(54) Machineable glass ceramic and manufacturing method thereof

(75) Inventors: Shogo Shimada, Fukuoka (JP); Takayuki Ide, Fukuoka (JP); Masakatsu Kiyohara, Fukuoka (JP); Akio Matsumoto, Fukuoka (JP)

Correspondence Address: CARRIER BLACKMAN AND ASSOCIATES, 24101 NOVI ROAD, SUITE 100, NOVI, MI, 48375, US

(73) Assignee: Toto Ltd., Kitakyusyu-shi (JP)

(21) Appl. No.: 12/004,839

(22) Filed: Dec. 21, 2007

Related U.S. Application Data
(63) Continuation of application No. PCT/JP2006/312525, filed on Jun. 22, 2006.

(30) Foreign Application Priority Data
Jun. 23, 2005 (JP) 2005-182801
Jun. 21, 2006 (JP) 2006-171079

(51) Int. Cl. C03C 10/16

(52) U.S. Cl. 501/3

(57) ABSTRACT

Object: To provide a machineable glass ceramic which has excellent machineable properties and various other physical property values.

Solution: A machineable glass ceramic comprises a glass matrix having substantially only fluorine phlogopite crystals dispersed therein, wherein an average dimension in the directions of major axes of said fluorine phlogopite crystals is less than 5 μm. The machineable glass ceramic constituted as above is produced by forming and degreasing glassy powder containing at least Si, Al, Mg, K, F and O, and thereafter by sintering the same at temperatures of 1000-1100 degrees centigrade.

### TECHNICAL FIELD

Aspects of the present invention relate to a machineable glass ceramic which has excellent machineable properties and various other kinds of physical property values such as bulk density, flexural strength, Young's modulus, hardness, volume resistivity, dielectric breakdown withstanding pressure, coefficient of thermal expansion, etc. and to a manufacturing method thereof.

### BACKGROUND ART

It is known that a machineable glass ceramic can be used as a material for electronic equipment, precision machines and/or inspection parts. With respect to machineable glass ceramics, the kind in which fluorine phlogopite (KMg₃(AlSi₃)₁₀F₂) is dispersed in a glassy matrix has excellent mechanical properties as well as insulation properties and machineable properties. The related art of such machineable glass ceramics is disclosed in patent references 1-4.

Patent reference 1 discloses a manufacturing method of a machineable glass ceramic comprising the steps of mixing two kinds of glass powder, granulating the mixed material powder, then forming a compact from the granulated material, and sintering the compact at temperatures of 1050 to 1150 degrees centigrade.

Patent reference 2 discloses the art where after obtaining a calcined body containing fluorine phlogopite crystals by calcining a material, the calcined body is sintered at temperatures of 1100 to 1250 degrees centigrade and then the sintered body is subjected to HIP (Hot Isostatic Pressing) and is thereby densified.

Patent reference 3 discloses a machineable glass ceramic where fluorine phlogopite crystals and zinc silicate crystals are deposited in the glass matrix obtained by granulating, forming and sintering the mixed powder.

Patent reference 4 discloses a machineable glass ceramic where mica and zirconia crystals are deposited in the glass matrix formed by a fusion method.

Patent reference 1: Japanese patent application publication No. H03-232740

Patent reference 2: Japanese patent application publication No. H04-182350

Patent reference 3: Japanese patent application publication No. H09-227223

Patent reference 4: Japanese patent application publication No. 2002-154842

### DISCLOSURE OF THE INVENTION

### Problem to be Solved by the Invention

One or more aspects of the present invention may provide a machineable glass ceramic which has as much strength as the conventional one and is excellent in machining accuracy.

### Means for Solving the Problem

To achieve the above mentioned objective, the machineable glass ceramic according to illustrative example of the present invention may include fluorine phlogopite crystals dispersed in a glass matrix wherein the glass matrix has the fluorine phlogopite crystals dispersed therein, and the average dimension in the directions of major axes of the fluorine phlogopite crystals is less than 5 μm.

Such micro-structure of the machineable glass ceramic as mentioned above may be obtained by forming and degreasing glassy powder containing at least Si, Al, Mg, K, F and O, and thereafter by sintering the same at temperatures of 1000 to 1100 degrees centigrade.

Further, the preferred composition ratio of the glassy powder may include 40 to 50 wt % of SiO₂, 10 to 20 wt % of Al₂O₃, 15 to 25 wt % of MgO, 5 to 15 wt % of K₂O, 5 to 10 wt % of F and 0.1 to 10 wt % of B₂O₃, so that minute fluorine phlogopite crystals can be homogeneously deposited by using the glassy powder of this composition.

Also, the preferred cumulative 50% grain diameter of the glassy powder may be less than 2 μm, so that by using the powder of this cumulative 50% grain diameter, it is possible to carry out sintering at a low temperature and the minute fluorine phlogopite crystals can be homogeneously deposited without calcination process.

Further, HIP may be carried out after the sintering process, so that it is possible to produce a dense sintered body in which substantially no pore is formed.

### EFFECTS OF THE INVENTION

The machineable glass ceramic of an illustrative example of the present invention has very minute fluorine phlogopite crystals dispersed in the glass matrix, so that surface roughness (Ra) in the case of cutting work is decreased. Also, it is possible to obtain superior physical property values such as mechanical strength, etc., than the conventional machineable glass ceramic.

Further, since the machineable glass ceramic of another illustrative example of the present invention has a homogeneous sintered body in comparison with the glass fusion method, it is possible to make larger products than in the past by using the machineable glass ceramic.

Furthermore, since the diameters of major axes of the fluorine phlogopite crystals are less than 5 μm, the machineable glass ceramic is excellent in machining accuracy while maintaining as much strength as the conventional machineable glass ceramic.

### BRIEF DESCRIPTION OF THE DRAWINGS

FIG. 1 (a) is a photomicrograph (SEM) of a machineable glass ceramic according to an embodiment of the present invention, (b) is a photomicrograph (SEM) of a guide hole portion of a probe card made from the machineable glass ceramic of an embodiment of the present invention, and (c) is a photomicrograph (SEM) of a guide hole portion of a probe card made from the conventional machineable glass ceramic;

FIG. 2 is a block diagram explaining a manufacturing process of the machineable glass ceramic according to an embodiment of the present invention;

FIG. 3 is a graph showing the relationship between the average grain diameter and sintering temperature of material powder and the density of a sintered body;

FIG. 4 is a photomicrograph (SEM) of granulated powder;

FIG. 5 is a graph with photomicrographs showing the relationship between the size of crystal (crystal area ratio) of the sintered body of an embodiment of the present invention and the sintering temperature;

FIGS. 6 (a) and (b) are photomicrographs showing the size of crystal of the conventional machineable glass ceramic;

FIG. 7 is a surface roughness profile of the machineable glass ceramic of an embodiment of the present invention;

FIG. 8 is an SEM image showing the structure of the machineable glass ceramic of an embodiment of the present invention;

FIG. 9 is a surface roughness profile of the conventional machineable glass ceramic; and

FIG. 10 is an SEM image showing the structure of the conventional machineable glass ceramic.

### BEST MODE FOR CARRYING OUT THE INVENTION

Although in the above-mentioned patent reference 1 there is a description that fluorine phlogopite is deposited by heating a glass powder material, it is impossible to form the fluorine phlogopite. Because in spite of a chemical formula of the fluorine phlogopite is (KMg₃(AlSi₃)₁₀F₂), Al₂O₃ which is necessary for the fluorine phlogopite to be deposited is not contained in the patent reference 1.

According to the method disclosed in the patent reference 2, it is possible to obtain the machineable glass ceramic which has the fluorine phlogopite crystals deposited in the glass matrix. However, since the calcining process is included, the size of crystal becomes not less than 5 μm, while since the transpiration of fluorine is increased due to calcination, the amount of fluorine phlogopite formation is decreased. As a result, the surface roughness (Ra, Rz) of the cutting surface is increased and the predetermined properties can not be obtained.

The glass ceramic disclosed in the patent reference 3 has a low coefficient of thermal expansion but is inferior in workability and mechanical property.

Further, the glass ceramic disclosed in the patent reference 4 has zinc silicate crystals other than the fluorine phlogopite deposited in the glass matrix, whereby a coefficient of thermal expansion can be decreased. However, since it is formed by the glass fusion method, a large amount of minute fluorine phlogopite crystals can not be deposited, whereby it is inferior in workability.

FIGS. 6 (a) and (b) are photomicrographs each showing the sizes of crystals of the currently available machineable glass ceramics, wherein in the conventional machineable glass ceramics, the sizes (major axes) of the fluorine phlogopite crystals are more than 5 μm.

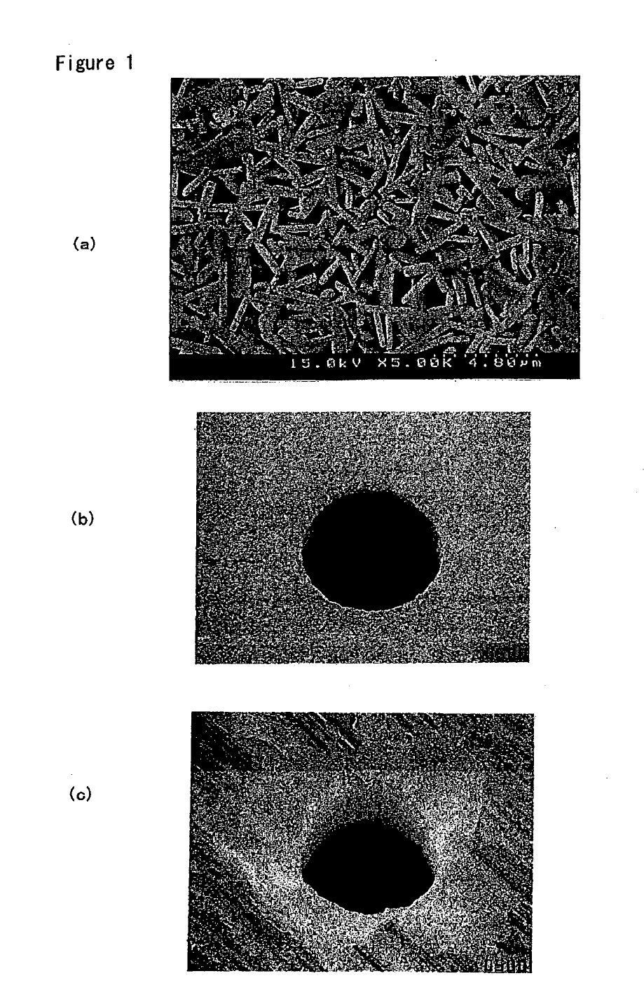

The embodiments of the present invention will be explained hereunder with reference to the accompanying drawings. FIG. 1 (a) is a photomicrograph (SEM) showing a machineable glass ceramic of an embodiments of the present invention. As apparent from this photomicrograph, fluorine phlogopite crystals are dispersed in a glass matrix while the average dimension in the directions of major axes of these fluorine phlogopite crystals is less than 5 μm. An average grain diameter is an average value obtained by measuring the diameters of major axes with respect to about 200 pieces of the fluorine phlogopite crystals on the basis of several photomicrographs of 5000 magnifications obtained by the SEM observation.

Further, FIG. 1 (b) is a photomicrograph (SEM) of a guide hole portion of a probe card (used for measurement of an electrical property of an IC chip, an LSI chip or the like) made from the machineable glass ceramic of an embodiment of the present invention, and FIG. 1 (c) is a photomicrograph (SEM) of a guide hole portion of a probe card made from the conventional machineable glass ceramic. As apparent from these photomicrographs, the machineable glass ceramic of an embodiment of the present invention has the average dimension of less than 5 μm in the directions of major axes of the fluorine phlogopite crystals and is superior in surface roughness. Therefore, a chip (chipping) around the hole seldom occurs in comparison with the case of using the conventional material.

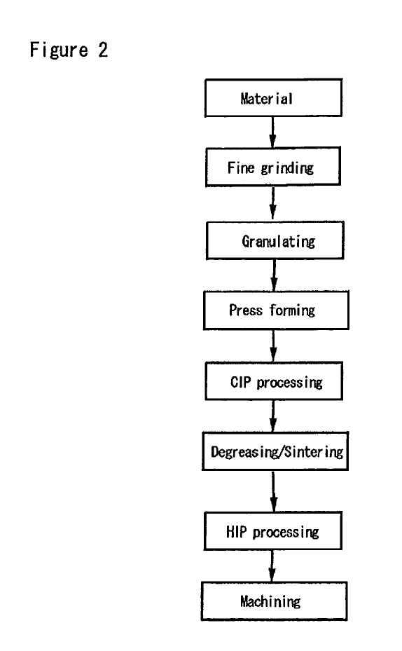

FIG. 2 is a block diagram explaining a manufacturing process of the machineable glass ceramic of an embodiment of the present invention.

Firstly, in this example, the material used is one whose composition ratio is 40 to 50 wt % of SiO₂, 10 to 20 wt % of Al₂O₃, 15 to 25 wt % of MgO, 5 to 15 wt % of K₂O, 5 to 10 wt % of F and 0.1 to 10 wt % of B₂O₃ and whose grain diameter is 3 to 5 μm.

The above material is ground by a pot mill so that a cumulative 50% grain diameter (d₅₀) is less than 2 μm and coarse grains of 10 μm or more are not contained. The material of less than 2 μm makes it possible to obtain a high density sintered body at a low temperature. A large amount of minute fluorine phlogopite can be deposited by being sintered at a low temperature.

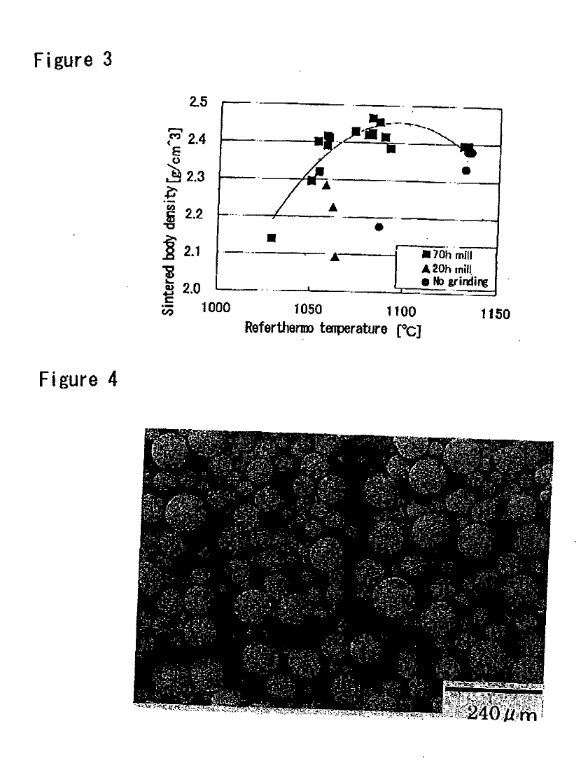

FIG. 3 is a graph showing the relationship between the average grain diameter and sintering temperature of the material powder and the density of the sintered body, wherein average grain diameters of the prepared material powder are (1) d₅₀=3.5 μm (not ground), (2) d₅₀=2.1 μm (20 h mill), and (3) d₅₀=1.4 μm (50 h mill).

As apparent from FIG. 3, as the average diameter of the material powder is smaller, the sintering can be carried out at lower temperatures, and moreover the density of the sintered body exceeds 2.4 g/cm³. The reason that the density is increased is because when the grain diameter is decreased by grinding, the specific surface area of the grain is increased thereby to accelerate the mass transfer in a low temperature range. On the other hand, it is thought that when the temperature exceeds 1100 degrees centigrade, the decomposition of the fluorine phlogopite starts to form pores, thereby preventing the density from being increased.

Next, granulating is carried out. In the granulating process, a dispersant, a binder and a mold releasing agent are mixed in the material to obtain a homogeneous granular material as shown in the photomicrograph (SEM) of FIG. 4 by the application of a spray drying method. A preferred granular grain diameter is 40 to 80 μm. When the grain diameter is less than 40 μm, there is a case where the material enters a clearance gap of a die at the time of following the forming process step thereby inhibiting pressure transmission. While when the grain diameter is more than 80 μm, there is a case of developing an uneven density. Further, in order to prevent cracks or cracking, it is required to control the water content of the granular material.

Forming is carried out with the granular material obtained by the granulation. When performing a CIP (Cold Isostatic Pressing) as a forming method for example, a preliminary press forming is carried out, prior to the CIP processing, with a uniaxial forming machine. Then, the compact obtained by the preliminary press forming is vacuum-packed by a thermo compression bonding sheet and is processed by the CIP processing.

Herein, it is preferable that the pressure for the preliminary press forming is 0.1 to 0.5 t/cm² and the pressure for the CIP processing is 1 to 2 t/cm².

The compact is degreased and sintered. When sintering, the temperature is raised to 600 to 800 degrees centigrade at 200 to 300 degrees centigrade per hour, kept at 600 to 800 degrees centigrade for four hours, then raised to 1000 to 1100 degrees centigrade at 200 to 300 degrees centigrade per hour to be kept for four hours, and after that, lowered for cooling.

When the temperature is kept at 600 to 800 degrees centigrade for four hours, the nucleation of the fluorine phlogopite crystals is carried out. When being kept at 1000 to 1100 degrees centigrade for four hours, the crystal growth is done. It is thought that, via the above sintering process, minute crystals can be deposited in large quantity.

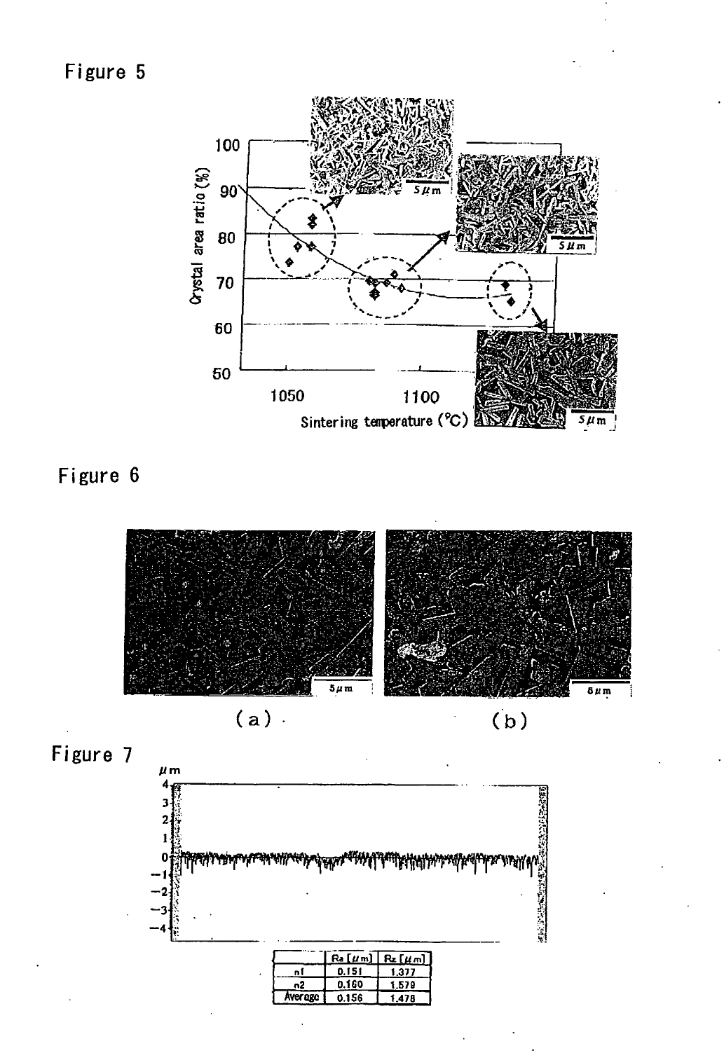

FIG. 5 is a graph with photomicrographs showing the relationship between the size of crystal (crystal area ratio) of the sintered body of an embodiment of the present invention and the sintering temperature. It is observed that in the case where the sintering temperatures are 1000 to 1100 degrees centigrade, the density is high and the sizes (major axes) of the fluorine phlogopite crystals are less than 5 μm. It is also observed that when the sintering temperature is raised higher than the above temperature, the fluorine phlogopite crystals are grown to be large in size and the ratio of a glass phase is increased. It is thought that the increase of the glass phase is due to decomposition of the fluorine phlogopite.

Since pores remain in the sintered body obtained as above, an HIP processing is carried out so as to obtain a dense body. The HIP processing is done at temperatures of 800 to 1000 degrees centigrade and at the pressures of 0.5 to 1.5 t/cm².

The following Table 1 shows a comparison in physical property values between the machineable glass ceramics of an embodiment of the present invention and the conventional ones, and Table 2 shows measuring methods of the physical property values. As shown in Table 1, the physical property values of the machineable glass ceramics are improved to a great extent in comparison with the conventional ones.

TABLE 1

| | | | Invented | Invented | Comparative | Comparative | Comparative |
|---|---|---|---|---|---|---|---|
| | | | product 1 | product 2 | example 1 | example 2 | example 3 |
| Composition | | | Fluorine | | Fluorine | Fluorine | Fluorine |
| | | | phlogopite | | phlogopite | phlogopite | phlogopite |
| General | Color | | white | white | white | yellow earth | white |
| property | Bulk density | g/cm³ | 2.59 | 2.54 | 2.55 | 2.67 | 2.59 |
| Mechanical | Flexural | MPa | 181 | 159 | 120 | 160 | 147 |
| property | strength | | | | | | |
| | Compressive | MPa | | | 440 | 440 | |
| | strength | | | | | | |
| | Young's | GPa | 63 | 70 | 86 | 65 | 66 |
| | modulus | | | | | | |
| | Poisson's | | | | 0.25 | 0.25 | |
| | ratio | | | | | | |
| | Hardness | GPa | 2.3 | 3.1 | 2.2 | 2.2 | 2.2 |
| Electrical | Volume | Ω · cm | 1.4 × 10¹⁵ | 1.4 × 10¹⁵ | 1 × 10¹⁵ | 5 × 10¹⁵ | 1.8 × 10¹⁵ |
| property | resistivity | (RT) | | | | | |
| | Dielectric | [1 MHz] | 6.2 | 7.3 | 6 | 6.5 | |
| | constant | [100 MHz] | | | | | 6.1 |
| | Dielectric | kv/mm | >20 | >20 | >10 | >10 | 18 |
| | breakdown | | | | | | |
| | withstand | | | | | | |
| | pressure | | | | | | |
| Thermal | Maximum | ° C. | | | 1200 | 700 | 1000 |
| property | allowable | | | | | | |
| | working | | | | | | |
| | temperature | | | | | | |
| | Coefficient | /° C. | 10.3 × 10⁻⁶ | 8.6 × 10⁻⁶ | 10.6 × 10⁻⁶ | 9.8 × 10⁻⁶ | 8.5 × 10⁻⁶ |
| | of thermal | | | | | | |
| | expansion | | | | | | |
| | Coefficient | W/m · K | | | 1.6 | 1.6 | 1.7 |
| | of thermal | | | | | | |
| | conductivity | | | | | | |
| | Specific heat | kJ/kg · K | | | 0.8 | 0.8 | |
| | Thermal | ° C. | | | 150 | 175 | 150 |
| | shock | | | | | | |
| | resistance | | | | | | |

RT~200° C.

TABLE 2

| Physical | |
|---|---|
| property value | Measuring method |
| Bulk density | Archimedes' method |
| Flexural strength | 3 point bending test based on JIS R1601 |
| Young's modulus | Calculated based on 3 point bending test |
| Hardness | Measured by Vickers hardness tester (load 2.5 kg) |
| Volume resistivity | Based on JIS C2141 |
| Dielectric breakdown | Based on JIS C2141 |
| withstand pressure | |
| Coefficient of | Measured from 50-600° C. by thermo-dilatometer |
| thermal expansion | (temperature up 10° C./min) |

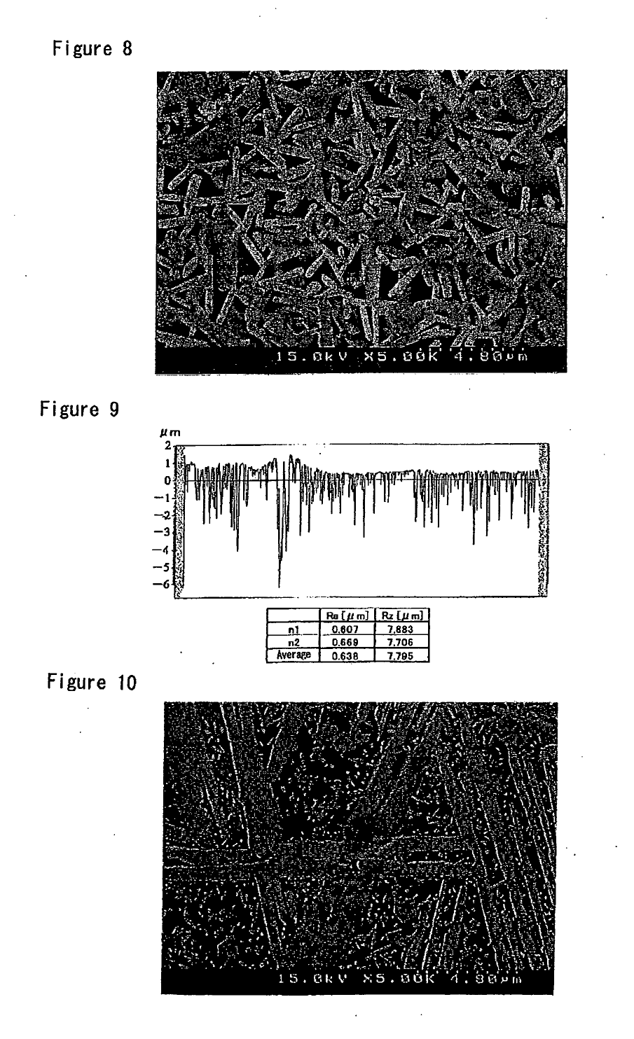

FIG. 7 and FIG. 8 show measurement results of the surface roughness (center line average surface roughness Ra and ten point average roughness Rz) and the SEM images of structure of the machineable glass ceramic of an embodiment of the present invention. While FIG. 9 and FIG. 10 show those of the conventional product. At the time of measuring the surface roughness the piercing is carried out with a φ1 mm carbide drill to pierce holes 6 mm deep at two points. The conditions for piercing are a feeding speed of 5 mm/min in 0.05 mm steps and a rotating speed of 6000 rpm. The pierced object is measured with a stylus type surface roughness tester of Taylor Hobson make (S4C ultra) in such a way that the pierced hole is cut into two halves and scanned 4.0 mm by the surface roughness tester along an inner wall of the hole in the depth direction. When making a comparison between the machineable glass ceramic of an embodiment of the present invention and the conventional product, Ra and Rz are apparently decreased more than the conventional product and the surface is formed smooth, so as to ensure good sliding between a probe and a probe card guide means. It is preferable for obtaining the good sliding property that Ra is 0.2 μm or less and Rz is 3.0 μm or less. Further, as apparent from the SEM images of the structure, the machineable glass ceramic of an embodiment of the present invention has smaller fluorine phlogopite crystals thereby allowing the surface roughness to be decreased.

### APPLICABILITY TO THE INDUSTRY

The machineable glass ceramic according to an embodiment of the present invention can be applied, for example, to a probe card or the like which is used for inspecting semiconductor devices such as IC or LSI.

1. A machineable glass ceramic comprising fluorine phlogopite crystals dispersed in a glass matrix; said glass matrix has the fluorine phlogopite crystals dispersed therein, and an average dimension in directions of major axes of said fluorine phlogopite crystals is less than 5 μm.

2. A method of manufacturing a machineable glass ceramic comprising fluorine phlogopite crystals dispersed in a glass matrix, comprising the steps of:
preparing a glassy powder, which contains at least Si, Al, Mg, K, F and O, and whose cumulative 50% grain diameter (d₅₀) is less that 2 μm,
forming the glassy powder into a compact,
decreasing the compact, and
thereafter sintered at temperatures of 1000 to 1100 degrees centigrade.

3. The method of manufacturing a machineable glass ceramic according to claim 2, wherein a composition ratio of said glassy powder comprises 40 to 50 wt % of SiO₂, 10 to 20 wt % of Al₂O₃, 15 to 25 wt % of MgO, 5 to 15 wt % of K₂O, 5 to 10 wt % of F and 0.1 to 10 wt % of B₂O₃.

4. The method of manufacturing a machineable glass ceramic according to claim 2, comprising a further step of HIP processing said sintered compact after said sintering process.

5. The method of manufacturing a machineable glass ceramic according to claim 3, comprising a further step of HIP processing said sintered compact after said sintering process.

6. The machineable glass ceramic according to claim 1, wherein said glass ceramic is formed from a glassy powder which contains at least Si, Al, Mg, K, F and O, and whose cumulative 50% grain diameter (d₅₀) is less that 2 μm.

7. The machineable glass ceramic according to claim 6, wherein a composition ratio of said glassy powder comprises 40 to 50 wt % of SiO₂, 10 to 20 wt % of Al₂O₃, 15 to 25 wt % of MgO, 5 to 15 wt % of K₂O, 5 to 10 wt % of F and 0.1 to 10 wt % of B₂O₃.

8. The machineable glass ceramic according to claim 6, wherein said glassy powder contains no coarse grains having a diameter of 10 μm or larger.

9. The method of manufacturing a machineable glass ceramic according to claim 3, wherein said glassy powder contains no coarse grains having a diameter of 10 μm or larger.

10. The method of manufacturing a machineable glass ceramic according to claim 2, wherein said forming step involves cold isostatic pressing.
